(19) United States
(12) Patent Application Publication
(10) Pub. No.: US 2026/0370273 A1
(43) Pub. Date: Nov. 19, 2026

(54) PRECODING METHOD, DEVICE, AND STORAGE MEDIUM

(71) Applicant: Beijing Xiaomi Mobile Software Co., Ltd., Beijing (CN)

(72) Inventors: Liangang CHI, Beijing (CN); Li YANG, Beijing (CN)

(21) Appl. No.: 19/142,558

(22) PCT Filed: Dec. 30, 2022
(86) PCT No.: PCT/CN2022/144319

§ 371 Date: Jun. 23, 2025

(51) Int. Cl. H04B 7/0456

(52) U.S. Cl. CPC H04B 7/0456

(57) ABSTRACT

A precoding method, where the precoding method includes: obtaining massive antenna array information of a second network device, where the massive antenna array information at least includes array partition information; determining precoding matrix indication information based on the array partition information included in the massive antenna array information, where the precoding matrix indication information is configured to determine, by the second network device, a precoding matrix for one or more array partitions in the massive antenna array; and sending the precoding matrix indication information to the second network device.

### CROSS-REFERENCE TO RELATED APPLICATIONS

The present application is a U.S. National Stage of International Application No. PCT/CN2022/144319, filed on Dec. 30, 2022, the contents of all of which are incorporated herein by reference in their entirety for all purposes.

### BACKGROUND OF THE INVENTION

Owing to continuous emergence of novel Internet applications such as a new generation of augmented reality (AR), virtual reality (VR) and vehicle-to-vehicle communication, higher requirements have been imposed on a wireless communication technology, driving continuous evolution of the wireless communication technology to satisfy the demand of the applications.

### SUMMARY OF THE INVENTION

The present disclosure relates to the technical field of communication, and in particular to a precoding method, a device, and a storage medium.

According to a first aspect of the embodiments of the present disclosure, a precoding method is provided. The precoding method is performed by a first network device, and includes: obtaining massive (large-scale) antenna array information of a second network device, where the massive antenna array information at least includes array partition information; determining precoding matrix indication information based on the array partition information included in the massive antenna array information, where the precoding matrix indication information is configured to determine, by the second network device, a precoding matrix for one or more array partitions included in a massive antenna array; and sending the precoding matrix indication information to the second network device.

According to a second aspect of the embodiments of the present disclosure, a precoding method is provided. The precoding method is performed by a second network device, and includes: receiving precoding matrix indication information sent by a first network device; and determining a precoding matrix for one or more array partitions included in a massive antenna array of the second network device, based on the precoding matrix indication information.

According to a third aspect of the embodiments of the present disclosure, a precoding method is provided. The precoding method is performed by a terminal, and includes:

determining precoding matrix indicator (PMI) information corresponding to a reference signal in one or more array partitions included in a massive antenna array of a second network device; and

sending the PMI information corresponding to the reference signal in the one or more array partitions to a first network device, where the PMI information is configured to determine precoding matrix indication information by the first network device, and the precoding matrix indication information is configured to determine, by the second network device, a precoding matrix for the one or more array partitions included in the massive antenna array.

According to a fourth aspect of the embodiments of the present disclosure, a communication device is provided. The device includes: one or more processors; and a memory configured to store processor-executable instructions, where the processor-executable instructions, when collectively executed by the one or more processors, cause the communication device to perform the precoding method of the third aspect.

According to a fifth aspect of the embodiments of the present disclosure, a non-transitory computer storage medium is provided. The non-transitory computer storage medium stores instructions, where the instructions, when executed by a processor of a terminal, cause the terminal to perform the precoding method of the third aspect.

It should be understood that the above general description and the following detailed description are only illustrative and explanatory, and cannot limit the present disclosure.

### BRIEF DESCRIPTION OF DRAWINGS

The accompanying drawings here are incorporated in the description as a constituent part of the description, illustrate the embodiments conforming to the present disclosure, and serve to explain the principles of the present disclosure along with the description.

FIG. 1 is a schematic diagram showing a communication system according to an example;

FIG. 2 is a schematic diagram showing another communication system according to an example;

FIG. 3 is a flowchart showing a precoding method according to an example;

FIG. 4 is a flowchart showing that precoding matrix indication information is determined according to an example;

FIG. 5 is a flowchart showing that precoding matrix indicator (PMI) information is determined according to an example;

FIG. 6 is a flowchart showing that a reference signal sent by an array partition is determined according to an example;

FIG. 7 is a flowchart showing a precoding method according to an example;

FIG. 8 is a flowchart showing that massive antenna array information is sent according to an example;

FIG. 9 is a flowchart showing that a reference signal sent by an array partition is determined according to an example;

FIG. 10 is a flowchart showing a precoding method according to an example;

FIG. 11 is a flowchart showing that PMI information is determined according to an example;

FIG. 12 is a flowchart showing that a reference signal sent by an array partition is determined according to an example;

FIG. 13 is a flowchart showing a precoding method according to an example;

FIG. 14 is a flowchart showing a precoding method according to an example;

FIG. 15 is a flowchart showing that precoding matrix indication information is determined according to an example;

FIG. 16 is a flowchart showing that a reference signal sent by an array partition is determined according to an example;

FIG. 17 is a flowchart showing a precoding method according to an example;

FIG. 18 is a flowchart showing that PMI information is determined according to an example;

FIG. 19 is a flowchart showing that a reference signal sent by an array partition is determined according to an example;

FIG. 20 is a flowchart showing a precoding method according to an example;

FIG. 21 is a block diagram showing a precoding device according to an example;

FIG. 22 is a block diagram showing a precoding device according to an example;

FIG. 23 is a block diagram showing a precoding device according to an example;

FIG. 24 is a block diagram showing a precoding device according to an example;

FIG. 25 is a block diagram showing a precoding device according to an example;

FIG. 26 is a block diagram showing a device for precoding according to an example; and

FIG. 27 is a block diagram showing a device for precoding according to an example.

### DETAILED DESCRIPTION OF THE INVENTION

The examples will be described in detail here, and are illustratively shown in the accompanying drawings. When the following description refers to the accompanying drawings, the same numbers in different accompanying drawings represent the same or similar elements unless otherwise indicated. The implementations described in the following examples do not represent all the implementations consistent with the present disclosure.

A precoding method provided by an embodiment of the present disclosure is applicable to various wireless communication systems. A wireless communication system of an embodiment of the present disclosure is a network providing a wireless communication function. Different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA) and carrier sense multiple access with collision avoidance, may be used for the wireless communication system. The network may be divided into a 2nd generation wireless communication system (2G) network, a 3rd generation wireless communication system (3G) network, a 4th generation wireless communication system (4G) network or a future evolution network such as a 5th generation wireless communication system (5G) network according to factors of capacity, a rate, a delay, etc. of different networks. The 5G network may also be referred to as a new radio (NR) network.

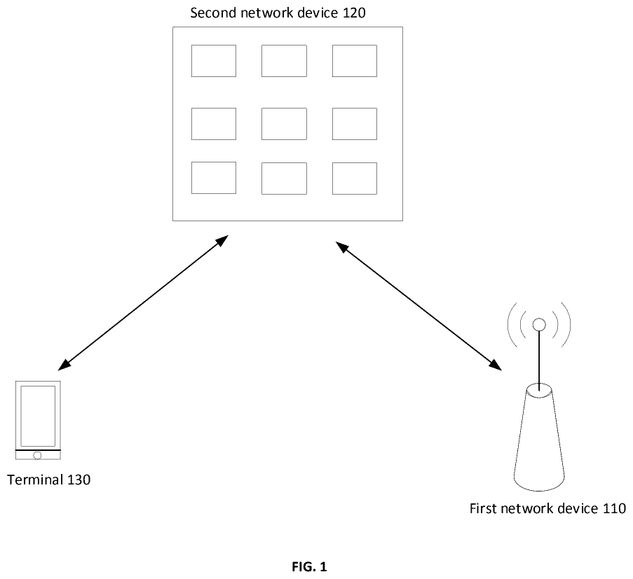

FIG. 1 is a schematic diagram showing a wireless communication system according to an embodiment of the present disclosure. With reference to FIG. 1, the wireless communication system may include a first network device 110, a second network device 120 and a terminal 130.

The second network device 120 has a massive antenna array. The first network device 110 sends a signal to the second network device 120, and the second network device 120 forwards the signal to the terminal 130 via the massive antenna array. The terminal 130 may also send the signal to the second network device 120, and the second network device 120 forwards the signal to the first network device 110 via the massive antenna array.

Further, the first network device 110 involved in the present disclosure may also be referred to as a radio access network device. The radio access network device may be a base station, an evolved node B (eNB), a home base station, an access point (AP) in a wireless fidelity (WIFI) system, a wireless relay node, a wireless backhaul node, a transmission point (TP), or a transmission and receiving point (TRP), may be further a next generation node B (gNB) in an NR system, or may be further a component or a part of a device constituting the base station. The network device may be further a vehicle-mounted device in a case of a vehicle to X (V2X) communication system. It should be understood that a specific technology and a specific device form used by the network device are not limited to the embodiment of the present disclosure.

Further, the second network device 120 involved in the present disclosure has the massive antenna array. In a case where the first network device 110 forwards the signal to the terminal 130 via the massive antenna array in the second network device 120, different antenna arrays in the massive antenna array of the second network device 120 may perform different phase offsets on the received signal, thus achieving the effect of an adjustable beam direction. Moreover, since an offset phase angle of the antenna array may only be a discrete value, it is necessary to configure an offset phase of the antenna array, that is, precoding, to forward an incidence signal to the terminal 130. Thus, the signal incident on the massive antenna array may be forwarded to a specific direction via the precoding technology. In this way, the signal strength at a receiver is improved. The second network device 120 involved in the present disclosure may be a device that may be deployed on a surface of various objects in a wireless transmission environment, such as a reconfigurable intelligent surface (RIS).

Further, the terminal 130 involved in the present disclosure may also be referred to as a terminal device, a user equipment (UE), a mobile station (MS), a mobile terminal (MT), etc., and the terminal 130 is a device that provides at least one of voice or data connectivity for a user. For example, the terminal may be a handheld device or a vehicle-mounted device having a wireless connection function. At present, some terminals include, for example, a mobile phone, a pocket personal computer (PPC), a palm computer, a personal digital assistant (PDA), a notebook computer, a tablet computer, a wearable device, or a vehicle-mounted device. Moreover, the terminal device may be further a vehicle-mounted device in a case of a V2X communication system. It should be understood that a specific technology and a specific device form used by the terminal are not limited to the embodiment of the present disclosure.

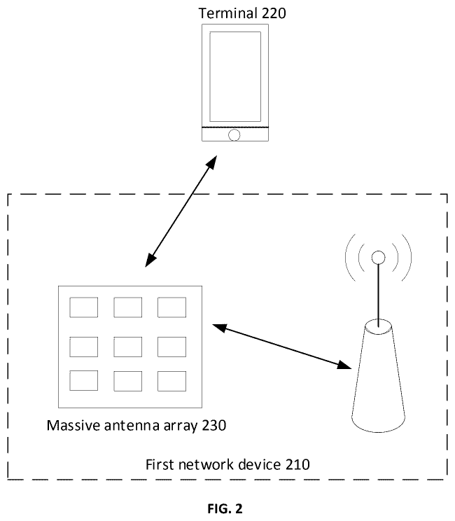

FIG. 2 is a schematic diagram showing another wireless communication system according to an embodiment of the present disclosure. With reference to FIG. 2, the wireless communication system includes a first network device 210 and a terminal 220.

The first network device 210 has a massive antenna array 230. A signal sent by the first network device 210 may be forwarded to the terminal 220 via the massive antenna array 230. The terminal 220 may also send the signal to the massive antenna array 230, and forward the signal to the first network device 210 via the massive antenna array 230.

Further, the first network device 210 involved in the present disclosure has the massive antenna array 230, and the first network device 210 may also be referred to as the radio access network device. The radio access network device may be the base station, the eNB, the home base station, the AP in the WIFI system, the wireless relay node, the wireless backhaul node, the TP, or the TRP, may be further the gNB in the NR system, or may be further the component or the part of the device constituting the base station. The network device may be further the vehicle-mounted device in a case of the V2X communication system. It should be understood that the specific technology and the specific device form used by the first network device are not limited to the embodiment of the present disclosure.

Further, the terminal 220 involved in the present disclosure may also be referred to as the terminal device, the UE, the MS, the MT, etc., and the terminal 220 is the device that provides at least one of the voice or the data connectivity for the user. For example, the terminal may be the handheld device or the vehicle-mounted device having the wireless connection function. At present, some terminals include, for example, the mobile phone, the PPC, the palm computer, the PDA, the notebook computer, the tablet computer, the wearable device, or the vehicle-mounted device. Moreover, the terminal device may be further the vehicle-mounted device in a case of the V2X communication system. It should be understood that the specific technology and the specific device form used by the terminal are not limited to the embodiment of the present disclosure.

It can be understood that the wireless communication systems shown in FIGS. 1 and 2 are only illustrative. The wireless communication system may further include other network devices, for example, a core network device, a wireless relay device and a wireless backhaul device, which are not shown in FIGS. 1 and 2.

At present, owing to continuous emergence of novel Internet applications such as a new generation of augmented reality (AR), virtual reality (VR) and vehicle-to-vehicle communication, higher requirements have been imposed on a wireless communication technology, driving continuous evolution of the wireless communication technology to satisfy the demand of the applications. Currently, a cellular mobile communication technology is in an evolution stage of a new generation of technology. A significant feature of the new generation of technology is that the flexible configuration of a plurality of types of services is supported. Different types of services have different requirements for the wireless communication technology. For example, a demand for an enhanced mobile broad band (eMBB) service focus on a large bandwidth and a high speed; a demand for an ultra reliable low latency communication (URLLC) service focus on high reliability and low latency; and a demand for a massive machine type communication (mMTC) service focus on the massive number of connections. Thus, a new generation of wireless communication system requires flexible and configurable designs to support transmission requirements of the plurality of types of services.

However, uncontrollability of a wireless transmission environment in the wireless communication technology typically has a negative impact on communication efficiency, and mainly causes reduction in quality of service. For example, a propagation distance of a wireless signal is limited by attenuation of the signal in the wireless transmission environment, a fading phenomenon is caused by a multi-path effect, and reflection and refraction of a large-sized object are even more uncontrollable. At present, it is considered to deploy a massive antenna array on a surface of an object, such as the RIS. A reference signal incidence on the surface is forwarded to the specific direction by precoding the antenna array. In this way, the signal strength at the receiver is enhanced and channel control is achieved.

However, in the related art, it is necessary to design a precoding matrix for the massive antenna array and a network device respectively by using different algorithms, resulting in excessively high complexity. Moreover, due to a large size of the massive antenna array, the transmission distance of the signal is not much different from the size of the massive antenna array. A traditional precoding method based on far field assumption is no longer applicable in a case where the massive antenna array operates in an environment with near field assumption.

In view of this, a precoding method is provided in an embodiment of the present disclosure. A precoding matrix for each array partition is determined separately by dividing a massive antenna array into a plurality of array partitions. Thus, complexity of precoding is reduced compared with the related art taking the massive antenna array as a whole for precoding. Moreover, by taking an array partition as a minimum reflection unit, the size of the array partition is greatly different from a transmission distance of a signal. Thus, the far field assumption is applicable to a single array partition.

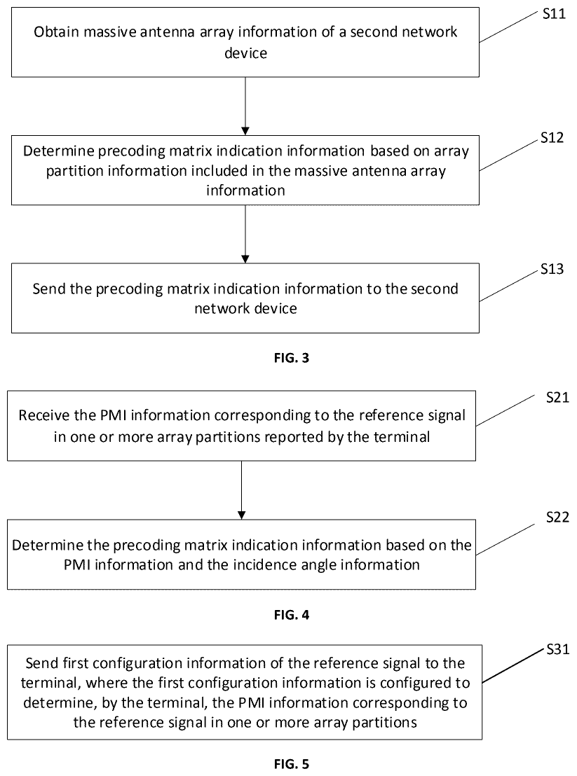

With the wireless communication system shown in FIG. 1 as an example, FIG. 3 is a flowchart showing a precoding method according to an example. As shown in FIG. 3, the precoding method is applied to the first network device, and includes the following steps.

In S11, obtain massive antenna array information of a second network device.

The massive antenna array information at least includes array partition information.

In an implementation, array partition information represents the number of array partitions included in the massive antenna array and at least one of the size of each array partition or the number of antennas of each array partition.

In some embodiments, the massive antenna array information may further include arrangement information of the massive antenna array and position information of a reference signal.

The arrangement information of the massive antenna array represents the number of antennas in a horizontal direction and a vertical direction separately in the massive antenna array information. The position information of the reference signal represents time-frequency position of the reference signal in the second network device.

In S12, determine precoding matrix indication information based on the array partition information included in the massive antenna array information.

The precoding matrix indication information is configured to determine, by the second network device, a precoding matrix for one or more array partitions included in the massive antenna array.

In an implementation, different array partitions correspond to different precoding matrices, or a plurality of array partitions correspond to the same precoding matrix.

In S13, send the precoding matrix indication information to the second network device.

In some embodiments, after receiving precoding matrix indication information, a second network device determines a precoding matrix for one or more array partitions included in a massive antenna array based on the precoding matrix indication information.

In the embodiment of the present disclosure, the precoding matrix indication information of the one or more array partitions included in the massive antenna array is determined by obtaining the massive antenna array information including the array partition information. After the precoding matrix indication information is sent to the second network device, the second network device can determine the precoding matrix for the one or more array partitions based on the precoding matrix indication information. It can be seen that in the embodiment of the present disclosure, the precoding matrix for each array partition is determined separately by dividing the massive antenna array into the plurality of array partitions. Thus, complexity of precoding is reduced compared with the related art taking the massive antenna array as a whole for precoding. Moreover, by taking the array partition as the minimum reflection unit, the size of the array partition is greatly different from the transmission distance of the signal. Thus, the far field assumption is applicable to a single array partition.

In the precoding method according to the embodiment of the present disclosure, the first network device obtains the massive antenna array information via the following methods: obtaining the massive antenna array information reported by the second network device; or obtaining the massive antenna array information stored offline by a core network device from the core network device.

In an implementation, the second network device directly reports the massive antenna array information to the first network device.

In another implementation, the core network device stores the massive antenna array information of the second network device, and the first network device obtains the massive antenna array information offline from the core network device.

For example, the core network device may be a device having an operation administration and maintenance (OAM) system.

In the precoding method according to the embodiment of the present disclosure, the first network device can determine the precoding matrix indication information based on precoding matrix indicator (PMI) information and incidence angle information.

The PMI information is determined by the terminal and reported to the first network device. The incidence angle information is determined by the first network device.

In an implementation, the terminal performs channel estimation according to the reference signal sent by the second network device, selects a most suitable precoding matrix from a codebook including the plurality of precoding matrices according to a channel estimation result, and feeds back the precoding matrix to the first network device via the PMI information.

In an implementation, the incidence angle information represents an incidence angle generated in a case where the first network device sends a signal to the second network device. Typically, positions of the first network device and the second network device are fixed. Thus, the incidence angle information is known for the first network device and the second network device.

FIG. 4 is a flowchart showing that the precoding matrix indication information is determined according to an example. As shown in FIG. 4, the method includes:

In S21, receive the PMI information corresponding to the reference signal in the one or more array partitions reported by the terminal.

In an implementation, the terminal performs channel estimation on the reference signal sent by each array partition to determine PMI information corresponding to the reference signal in each array partition.

In some embodiments, the PMI information includes a horizontal PMI and a vertical PMI.

In S22, determine the precoding matrix indication information based on the PMI information and the incidence angle information.

In some embodiments, the precoding matrix indication information includes: at least one of a PMI or a phase coefficient corresponding to the precoding matrix for the one or more array partitions. After the precoding matrix indication information is sent to the second network device, the second network device determines the precoding matrix for each array partition according to at least one of the PMI or the phase coefficient corresponding to each array partition.

In an implementation, a phase needs to be adjusted for a PMI corresponding to an array partition. Thus, a phase to be adjusted for the array partition is determined via a phase coefficient.

In some embodiments, the precoding matrix indication information includes: the precoding matrix for the one or more array partitions. After the precoding matrix indication information is sent to the second network device, the second network device directly determines the precoding matrix for each array partition according to the precoding matrix indication information.

Determination of the precoding matrix for the array partition by the first network device will be described below with examples.

An array partition having a size of M*N is taken as an example. A horizontal PMI and a vertical PMI corresponding to a reference signal in the array partition reported by the terminal are received, and corresponding angle vectors are determined according to the horizontal PMI and the vertical PMI:

$$a ( {m}_{1} ) = [ 1 , {e}^{J \frac{2 π {m}_{1}}{{NO}_{1}}} , {e}^{j \frac{2 π 2 {m}_{1}}{{NO}_{1}}} , … , {e}^{j \frac{2 π ( N - 1 ) {m}_{1}}{{NO}_{1}}} ]$$

$$a ( {m}_{2} ) = [ 1 , {e}^{J \frac{2 π {m}_{2}}{{NO}_{2}}} , {e}^{j \frac{2 π 2 {m}_{2}}{{NO}_{2}}} , … , {e}^{j \frac{2 π ( N - 1 ) {m}_{2}}{{NO}_{2}}} ]$$

m₁ represents the horizontal PMI corresponding to the reference signal in the array partition, m₂ represents the vertical PMI corresponding to the reference signal in the array partition, α(m₁) represents the angle vector to be supplemented in the horizontal dimension determined based on the horizontal PMI, α(m₂) represents the angle vector to be supplemented in the vertical dimension determined based on the vertical PMI, O₁ and O₂ represent oversampling factors, and j represents an imaginary part.

Corresponding angle vectors are determined according to an incidence angle in the horizontal dimension and an incidence angle in the vertical dimension:

$$a ( {α}_{h} ) = [ 1 , {e}^{j \frac{2 π}{λ} {d}_{1} cos {α}_{h}} , {e}^{j \frac{2 π}{λ} 2 {d}_{1} cos {α}_{h}} , … , {e}^{j \frac{2 π}{λ} {Nd}_{1} cos {α}_{h}} ]$$

$$a ( {α}_{v} ) = [ 1 , {e}^{j \frac{2 π}{λ} {d}_{2} cos {α}_{v}} , {e}^{j \frac{2 π}{λ} 2 {d}_{2} cos {α}_{v}} , … , {e}^{j \frac{2 π}{λ} {Md}_{2} cos {α}_{v}} ]$$

αₕ represents the incidence angle in the horizontal dimension, ay represents the incidence angle in the vertical dimension, α(αₕ) represents the angle vector to be supplemented in the horizontal dimension determined according to the incidence angle in the horizontal dimension, α(αᵥ) represents the angle vector to be supplemented in the vertical dimension determined according to the incidence angle in the vertical dimension, d₁ represents an antenna spacing in a horizontal direction in the array partition, d₂ represents an antenna spacing in a vertical direction in the array partition, and j represents the imaginary part.

Thus, the angle vector of the array partition to be supplemented in the horizontal dimension is: α(γₕ)=α(m₁)⊙α(αₕ)·γₕ represents an angle of the array partition to be supplemented in the horizontal dimension, α(γₕ) represents the angle vector of the array partition to be supplemented in the horizontal dimension, α(m₁) represents the angle vector to be supplemented in the horizontal dimension determined based on the horizontal PMI, and α(αₕ) represents the angle vector to be supplemented in the horizontal dimension determined according to the incidence angle in the horizontal dimension.

The angle vector of the array partition to be supplemented in the vertical direction is: α(γᵥ)=α(m₂)⊙α(αᵥ)·γᵥ represents the angle of the array partition to be supplemented in the vertical dimension, α(γᵥ) represents the angle vector of the array partition to be supplemented in the vertical dimension, α(m₂) represents the angle vector to be supplemented in the vertical dimension determined based on the vertical PMI, and α(αᵥ) represents the angle vector to be supplemented in the vertical dimension determined according to the incidence angle in the vertical dimension.

Further, a precoding matrix for the array partition is α(γᵥ)^{T}×α(γₕ).

In the embodiment of the present disclosure, the first network device can determine the precoding matrix indication information corresponding to the one or more array partitions by receiving the PMI information corresponding to the reference signal in the one or more array partitions reported by the terminal. After sending the precoding matrix indication information to the second network device, the second network device can determine the precoding matrix for the one or more array partitions based on the precoding matrix indication information. It can be seen that in the embodiment of the present disclosure, the precoding matrix for each array partition is determined separately by dividing the massive antenna array into the plurality of array partitions. Thus, complexity of precoding is reduced compared with the related art taking the massive antenna array as a whole for precoding.

How to obtain the PMI information reported by the terminal will be described below.

FIG. 5 is a flowchart showing that the PMI information is determined according to an example. As shown in FIG. 5, the method includes the following step.

In S31, send first configuration information of the reference signal to the terminal, where the first configuration information is configured to determine, by the terminal, the PMI information corresponding to the reference signal in the one or more array partitions.

In some embodiments, the first network device configures and activates the reference signal based on reference signal position information included in the massive antenna array information to determine the first configuration information of the reference signal, and sends the first configuration information to the terminal. After receiving the first configuration information of the reference signal, the terminal performs channel estimation on the reference signal in each array partition to determine PMI information corresponding to each array partition.

In the embodiment of the present disclosure, the terminal determines the PMI information corresponding to the reference signal in the one or more array partitions based on the first configuration information of the reference signal by sending the first configuration information of the reference signal to the terminal. Thus, after the terminal reports the PMI information to the first network device, the first network device can determine the precoding matrix indication information of the one or more partitions based on the PMI information. After the first network device sends the precoding matrix indication information to the second network device, the second network device can determine the precoding matrix for the one or more array partitions based on the precoding matrix indication information. It can be seen that in the embodiment of the present disclosure, the precoding matrix for each array partition is determined separately by dividing the massive antenna array into the plurality of array partitions. Thus, complexity of precoding is reduced compared with the related art taking the massive antenna array as a whole for precoding.

In the precoding method according to the embodiment of the present disclosure, the first configuration information includes at least one of:
an array partition corresponding to the reference signal;
a time-frequency resource occupied by the reference signal; or
sequence information of the reference signal.

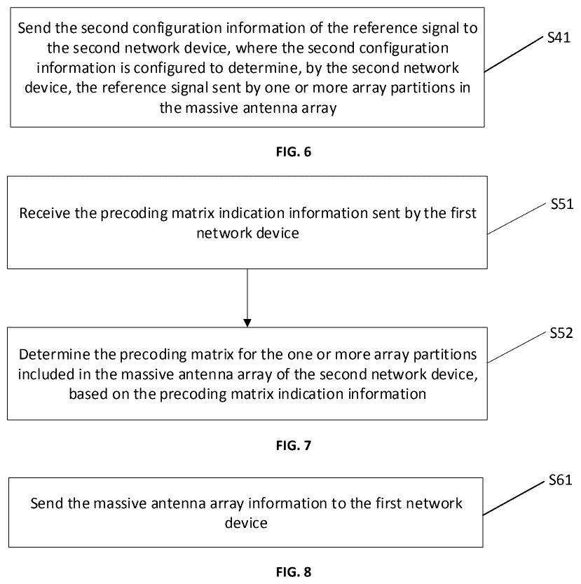

In the precoding method according to the embodiment of the present disclosure, in a case where the terminal performs channel estimation on the reference signal in each array partition, the terminal further needs to receive the reference signal sent by the second network device via the array partition. Thus, the second network device needs to determine the reference signal sent by each array partition. Thus, after configuring and activating the reference signal based on reference signal position information included in the massive antenna array information, the first network device determines the second configuration information of the reference signal, and sends the second configuration information of the reference signal to the second network device. Thus, the second network device determines the reference signal sent by each array partition based on the second configuration information. On this basis, a flowchart showing that the reference signal sent by the array partition is determined is further provided in an embodiment of the present disclosure. As shown in FIG. 6, the method includes the following step.

In S41, send the second configuration information of the reference signal to the second network device, where the second configuration information is configured to determine, by the second network device, the reference signal sent by the one or more array partitions in the massive antenna array.

In the embodiment of the present disclosure, the second network device determines the reference signal sent by the one or more array partitions based on the second configuration information, and sends the corresponding reference signal to the terminal based on the one or more array partitions. After receiving the reference signal, the terminal performs channel estimation on the reference signal based on the first configuration information of the reference signal to determine the PMI information corresponding to the reference signal sent by the array partitions, and reports the PMI information to the first network device. Thus, the first network device determines the precoding matrix indication information corresponding to the array partitions based on the PMI information.

In the precoding method according to the embodiment of the present disclosure, two manners of reporting the PMI information by the terminal are provided in a case where the terminal reports the PMI information to the first network device.

In some embodiments, the PMI information corresponding to the reference signal in the one or more array partitions reported by the terminal at one time is received.

In some other embodiments, the PMI information corresponding to the reference signal in the one or more array partitions reported by the terminal at one time is received.

In the precoding method according to the embodiment of the present disclosure, the second network device is the RIS, and the massive antenna array is an RIS array.

FIG. 7 is a flowchart of a precoding method according to an example. As shown in FIG. 7, the precoding method is applied to the second network device, and includes the following steps.

In S51, receive the precoding matrix indication information sent by the first network device.

In S52, determine the precoding matrix for the one or more array partitions included in the massive antenna array of the second network device, based on the precoding matrix indication information.

In an implementation, different array partitions correspond to different precoding matrices, or the plurality of array partitions correspond to the same precoding matrix.

In the embodiment of the present disclosure, the second network device can determine the precoding matrix for the one or more array partitions based on the precoding matrix indication information by receiving the precoding matrix indication information sent by the first network device. It can be seen that in the embodiment of the present disclosure, the precoding matrix for each array partition is determined separately by dividing the massive antenna array into the plurality of array partitions. Thus, complexity of precoding is reduced compared with the related art taking the massive antenna array as a whole for precoding. Moreover, by taking the array partition as the minimum reflection unit, the size of the array partition is greatly different from the transmission distance of the signal. Thus, the far field assumption is applicable to the single array partition.

In some embodiments, the precoding matrix indication information is determined by the first network device based on the PMI information and the incidence angle information.

The PMI information is determined by the terminal and reported to the first network device. The incidence angle information is determined by the first network device.

In an implementation, the terminal performs the channel estimation according to the reference signal sent by the second network device, selects the most suitable precoding matrix from the codebook including the plurality of precoding matrices according to the channel estimation result, and feeds back the precoding matrix to the first network device via the PMI information.

In an implementation, the incidence angle information represents an incidence angle generated in a case where the first network device sends a signal to the second network device. Typically, positions of the first network device and the second network device are fixed. Thus, the incidence angle information is known for the first network device and the second network device.

In the precoding method according to the embodiment of the present disclosure, the precoding matrix indication information includes: at least one of a PMI or a phase coefficient corresponding to the precoding matrix for the one or more array partitions; or the precoding matrix for the one or more array partitions.

In an implementation, in response to the precoding matrix indication information, it includes at least one of the PMI or the phase coefficient corresponding to the precoding matrix for the one or more array partitions. After the precoding matrix indication information is sent to the second network device, the second network device determines the precoding matrix for each array partition according to at least one of the PMI or the phase coefficient corresponding to each array partition.

The phase needs to be adjusted for the PMI corresponding to the array partition. Thus, the phase to be adjusted for the array partition is determined via the phase coefficient.

In another implementation, in response to the precoding matrix indication information, it includes the precoding matrix for the one or more array partitions. After the precoding matrix indication information is sent to the second network device, the second network device directly determines the precoding matrix for each array partition according to the precoding matrix indication information.

In the precoding method according to the embodiment of the present disclosure, since the second network device can determine the precoding matrix for the one or more array partitions included in the massive antenna array based on the precoding matrix indication information, the first network device needs to obtain the array partition information of the one or more array partitions included in the massive antenna array of the second network device in a case where the first network device determines the precoding matrix indication information.

In some embodiments, the second network device sends the massive antenna array information including the array partition information to the first network device, or the first network device obtains the massive antenna array information including the array partition information offline from a core network device storing the massive antenna array information including the array partition information.

On this basis, a method for sending the massive antenna array information is further provided in an embodiment of the present disclosure. As shown in FIG. 8, the method includes the following step.

In S61, send the massive antenna array information to the first network device.

The massive antenna array information at least includes the array partition information. The array partition information is configured to determine the precoding matrix indication information by the first network device.

In an implementation, the array partition information represents the number of array partitions included in the massive antenna array; and at least one of the size of each array partition or the number of antennas of each array partition.

In some embodiments, the massive antenna array information may further include arrangement information of the massive antenna array and position information of the reference signal.

The arrangement information of the massive antenna array represents the number of antennas in a horizontal direction and a vertical direction separately in the massive antenna array information. The position information of the reference signal represents the time-frequency position of the reference signal in the second network device.

In the embodiment of the present disclosure, the first network device can separately determine the precoding matrix indication information corresponding to the array partitions for the plurality of array partitions by dividing the massive antenna array information into the plurality of array partitions. Thus, complexity of precoding is reduced compared with the related art taking the massive antenna array as a whole for precoding. Moreover, by taking the array partition as the minimum reflection unit, the size of the array partition is greatly different from the transmission distance of the signal. Thus, the far field assumption is applicable to the single array partition.

In the precoding method according to the embodiment of the present disclosure, after receiving the massive antenna array information, the first network device can configure and activate the reference signal based on the reference signal position information included in the massive antenna array information, and determine the second configuration information of the reference signal. After sending the second configuration information of the reference signal to the second network device, the second network device can determine the reference signal sent by each array partition based on the second configuration information, so as to send the corresponding reference signal to the terminal via the array partition. After receiving the reference signal sent by the array partition, the terminal performs the channel estimation on the reference signal in the array partition to determine the PMI information corresponding to the array partition. Thus, the terminal can report the PMI information to the first network device, such that the first network device determines the precoding matrix indication information corresponding to the array partition based on the PMI information.

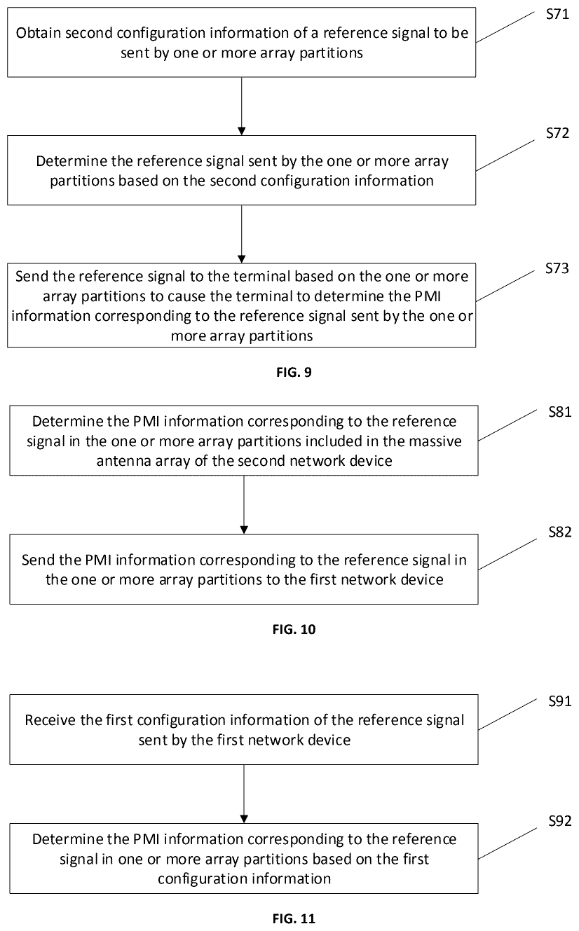

On this basis, a method for determining the reference signal sent by the array partition is further provided in an embodiment of the present disclosure. As shown in FIG. 9, the method includes the following steps.

In S71, obtain second configuration information of a reference signal to be sent by the one or more array partitions.

In S72, determine the reference signal sent by the one or more array partitions based on the second configuration information.

In S73, send the reference signal to the terminal based on the one or more array partitions to cause the terminal to determine the PMI information corresponding to the reference signal sent by the one or more array partitions.

In the embodiment of the present disclosure, the second network device sends the reference signal to the terminal based on the one or more array partitions such that the terminal can perform the channel estimation on the reference signal, and determine the PMI information corresponding to each array partition. Complexity of precoding is reduced compared with the related art taking the massive antenna array as a whole for precoding. Moreover, by taking the array partition as the minimum reflection unit, the size of the array partition is greatly different from the transmission distance of the signal. Thus, the far field assumption is applicable to the single array partition.

In the precoding method according to the embodiment of the present disclosure, in a case where the second network device obtains the second configuration information of the reference signal to be sent by the one or more array partitions, the second network device can determine the second configuration information of the reference signal by receiving signaling sent by the first network device, or can obtain the second configuration information of the reference signal stored offline by the core network device from the core network device.

The core network device may be the device having the OAM system.

In the precoding method according to the embodiment of the present disclosure, the second network device is the RIS, and the massive antenna array is the RIS array.

FIG. 10 is a flowchart of a precoding method according to an example. As shown in FIG. 10, the precoding method is applied to the terminal, and includes the following steps.

In S81, determine the PMI information corresponding to the reference signal in the one or more array partitions included in the massive antenna array of the second network device.

In an implementation, the terminal performs the channel estimation according to the reference signal sent by the second network device, selects the most suitable precoding matrix from the codebook including the plurality of precoding matrices according to the channel estimation result, and determines the PMI information via the precoding matrix.

In S82, send the PMI information corresponding to the reference signal in the one or more array partitions to the first network device.

The PMI information is configured to determine the precoding matrix indication information, by the first network device, and the precoding matrix indication information is configured to determine, by the second network device, the precoding matrix for the one or more array partitions included in the massive antenna array.

In some embodiments, the precoding matrix indication information is determined by the first network device based on the PMI information and the incidence angle information.

The PMI information is determined by the terminal and reported to the first network device. The incidence angle information is determined by the first network device.

In an implementation, the terminal performs the channel estimation according to the reference signal sent by the second network device, selects the most suitable precoding matrix from the codebook including the plurality of precoding matrices according to the channel estimation result, and feeds back the precoding matrix to the first network device via the PMI information. Incidence angle information represents an incidence angle generated in a case where the first network device sends the signal to the second network device. Typically, positions of the first network device and the second network device are fixed. Thus, the incidence angle information is known for the first network device and the second network device.

In some embodiments, the precoding matrix indication information may include: at least one of a PMI or a phase coefficient corresponding to the precoding matrix for the one or more array partitions; or the precoding matrix for the one or more array partitions.

In an implementation, in response to the precoding matrix indication information, it includes at least one of the PMI or the phase coefficient corresponding to the precoding matrix for the one or more array partitions. After the first network device sends the precoding matrix indication information to the second network device, the second network device determines the precoding matrix for each array partition according to at least one of the PMI or the phase coefficient corresponding to each array partition.

The phase needs to be adjusted for the PMI corresponding to the array partition. Thus, the phase to be adjusted for the array partition is determined via the phase coefficient.

In another implementation, in response to the precoding matrix indication information, it includes the precoding matrix in the one or more array partitions. After the first network device sends the precoding matrix indication information to the second network device, the second network device directly determines the precoding matrix for each array partition according to the precoding matrix indication information.

In the embodiment of the present disclosure, the terminal can determine the PMI information corresponding to the reference signal in the one or more array partitions included in the massive antenna array of the second network device. After sending the PMI information corresponding to the reference signal in the one or more array partitions to the first network device, the first network device can determine the precoding matrix indication information of the one or more array partitions based on the PMI information. It can be seen that in the embodiment of the present disclosure, the precoding matrix indication information of each array partition is determined separately by dividing the massive antenna array into the plurality of array partitions. Thus, complexity of precoding is reduced compared with the related art taking the massive antenna array as a whole for precoding. Moreover, by taking the array partition as the minimum reflection unit, the size of the array partition is greatly different from the transmission distance of the signal. Thus, the far field assumption is applicable to the single array partition.

In the precoding method according to the embodiment of the present disclosure, when determining the PMI information corresponding to the reference signal in the one or more array partitions, the terminal needs to obtain configuration information of the reference signal to determine a corresponding relation between the reference signal and the array partitions, so as to perform the channel estimation on the reference signal in each array partition and determine the PMI information corresponding to each array partition.

On this basis, a method for determining PMI information is further provided in an embodiment of the present disclosure. As shown in FIG. 11, the method includes the following steps.

In S91, receive the first configuration information of the reference signal sent by the first network device.

The first configuration information is determined by the first network device by configuring and activating the reference signal based on the reference signal position information included in the massive antenna array information.

In S92, determine the PMI information corresponding to the reference signal in the one or more array partitions based on the first configuration information.

In some embodiments, the first configuration information includes at least one of:
the array partition corresponding to the reference signal;
the time-frequency resource occupied by the reference signal; or
the sequence information of the reference signal.

In the embodiment of the present disclosure, the terminal determines the PMI information corresponding to the reference signal in the one or more array partitions based on the first configuration information of the reference signal by sending the first configuration information of the reference signal to the terminal. Thus, after the terminal reports the PMI information to the first network device, the first network device can determine the precoding matrix indication information of the one or more partitions based on the PMI information. After the first network device sends the precoding matrix indication information to the second network device, the second network device can determine the precoding matrix for the one or more array partitions based on the precoding matrix indication information. It can be seen that in the embodiment of the present disclosure, the precoding matrix for each array partition is determined separately by dividing the massive antenna array into the plurality of array partitions. Thus, complexity of precoding is reduced compared with the related art taking the massive antenna array as a whole for precoding.

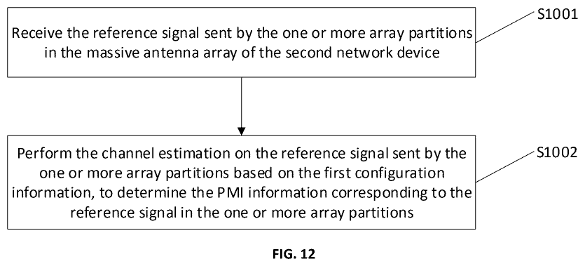

In the precoding method according to the embodiment of the present disclosure, when performing the channel estimation on the reference signal in each array partition, the terminal further needs to receive the reference signal sent by the second network device via the array partition, and further performs the channel estimation on the received reference signal to determine the corresponding PMI information. On this basis, a method for determining the reference signal sent by the array partition is further provided in an embodiment of the present disclosure. As shown in FIG. 12, the method includes the following steps.

In S1001, receive the reference signal sent by the one or more array partitions in the massive antenna array of the second network device.

The second network device determines the reference signal sent by the one or more array partitions based on the second configuration information of the reference signal, and sends the corresponding reference signal to the terminal based on the one or more array partitions.

S1002, perform the channel estimation on the reference signal sent by the one or more array partitions based on the first configuration information, to determine the PMI information corresponding to the reference signal in the one or more array partitions.

In the embodiment of the present disclosure, the second network device sends the reference signal to the terminal based on the one or more array partitions such that the terminal can perform the channel estimation on the reference signal, and determine the PMI information corresponding to each array partition. Complexity of precoding is reduced compared with the related art taking the massive antenna array as a whole for precoding. Moreover, by taking the array partition as the minimum reflection unit, the size of the array partition is greatly different from the transmission distance of the signal. Thus, the far field assumption is applicable to the single array partition.

In the precoding method according to the embodiment of the present disclosure, two manners of reporting the PMI information by the terminal are provided in a case where the terminal reports the PMI information to the first network device.

In some embodiments, the PMI information corresponding to the reference signal in one or more array partitions is reported to the first network device at one time.

In some other embodiments, the PMI information corresponding to the reference signal in one or more array partitions is reported to the first network device a plurality of times.

The PMI information reported each time of the plurality of times includes the PMI information corresponding to the reference signal in the one or more array partitions.

In the precoding method according to the embodiment of the present disclosure, the second network device is the RIS, and the massive antenna array is the RIS array.

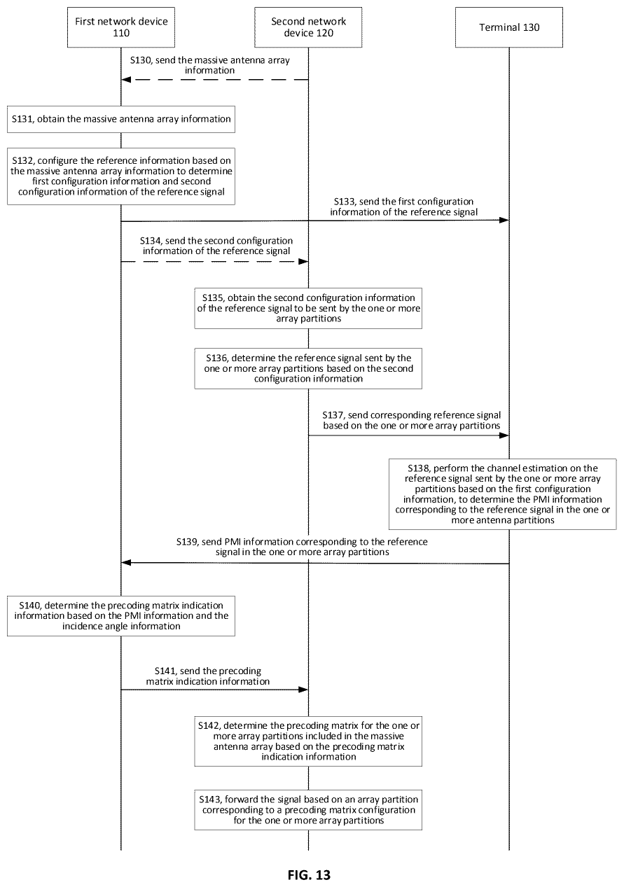

In order to more clearly explain the precoding method according to the embodiment of the present disclosure, the precoding method according to the embodiment of the present disclosure will be described below in an interactive form. As shown in FIG. 13, the precoding method includes the following steps.

S131, the first network device 110 obtains the massive antenna array information.

S132, the first network device 110 configures the reference signal based on the massive antenna array information to determine first configuration information and second configuration information of the reference signal. The massive antenna array information at least includes partition information of array partitions. As shown in FIG. 13, the precoding method further includes S130: the first network device 110 may receive the massive antenna array information sent by the second network device 120, or obtain the massive antenna array information stored by the core network device from the core network device.

S133, the first network device 110 sends the first configuration information of the reference signal to the terminal 130.

S134, the first network device 110 sends the second configuration information of the reference signal to the second network device 120 or stores the second configuration information of the reference signal in the core network device.

S135, the second network device 120 obtains the second configuration information of the reference signal to be sent by the one or more array partitions from the first network device 110 or the core network device.

S136, the second network device 120 determines the reference signal sent by the one or more array partitions based on the second configuration information.

S137, the second network device 120 sends the reference signal to the terminal 130 based on the one or more array partitions.

S138, after receiving the first configuration information and the reference signal sent by the one or more array partitions, the terminal 130 performs the channel estimation on the reference signal in the one or more array partitions to determine the PMI information corresponding to the reference signal in the one or more array partitions via measurement.

S139, the terminal 130 sends the PMI information corresponding to the reference signal in the one or more array partitions to the first network device 110.

S140, the first network device 110 determines the precoding matrix indication information of the one or more partitions according to the received PMI information and the incidence angle information.

S141, the first network device 110 sends the precoding matrix indication information to the second network device 120.

S142, after receiving the precoding matrix indication information, the second network device 120 determines the precoding matrix corresponding to the one or more array partitions based on the precoding matrix indication information.

S143, the second network device 120 forwards the signal based on an array partition corresponding to a precoding matrix configuration for the one or more array partitions. That is, the second network device 120 configures an antenna port corresponding to the precoding matrix based on the precoding matrix corresponding to the one or more array partitions, so as to forward the signal.

In some embodiments, in a case where the massive antenna array is the RIS array of the RIS, the signal may be at least one of reflected or transmitted.

In the embodiment of the present disclosure, the precoding matrix for each array partition is determined separately by dividing the massive antenna array into the plurality of array partitions. Thus, complexity of precoding is reduced compared with the related art taking the massive antenna array as a whole for precoding. Moreover, by taking the array partition as the minimum reflection unit, the size of the array partition is greatly different from the transmission distance of the signal. Thus, the far field assumption is applicable to the single array partition.

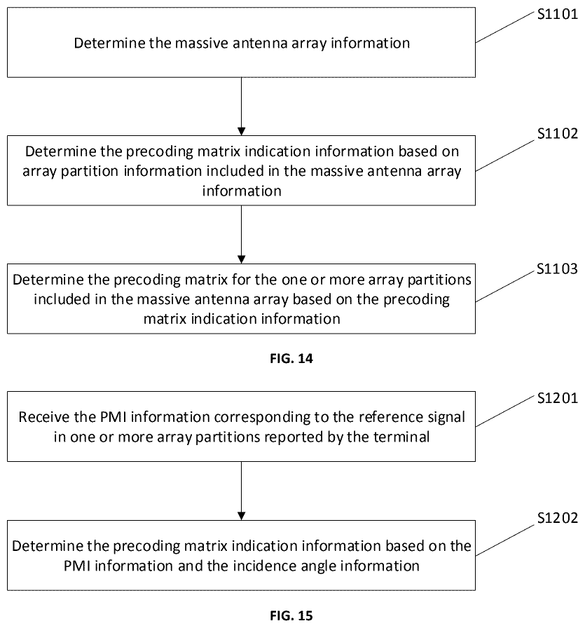

With the wireless communication system shown in FIG. 2 as an example, FIG. 14 is a flowchart of a precoding method according to an example. As shown in FIG. 14, the precoding method is applied to the first network device, and includes the following steps.

In S1101, determine the massive antenna array information.

The massive antenna array information at least includes the array partition information.

In an implementation, the array partition information represents the number of array partitions included in the massive antenna array and at least one of the size of each array partition or the number of antennas of each array partition.

In some embodiments, the massive antenna array information may further include the arrangement information of the massive antenna array and the position information of the reference signal.

The arrangement information of the massive antenna array represents the number of antennas in the horizontal direction and the vertical direction separately in the massive antenna array information. The position information of the reference signal represents the time-frequency position of the reference signal in the first network device.

In S1102, determine the precoding matrix indication information based on the array partition information included in the massive antenna array information.

In an implementation, different array partitions correspond to different precoding matrices, or the plurality of array partitions correspond to the same precoding matrix.

In S1103, determine the precoding matrix for the one or more array partitions included in the massive antenna array based on the precoding matrix indication information.

In the embodiment of the present disclosure, the first network device can determine the precoding matrix indication information of the one or more array partitions in the massive antenna array, and thus can determine the precoding matrix for the one or more array partitions included in the massive antenna array. Thus, complexity of precoding is reduced compared with the related art taking the massive antenna array as a whole for precoding. Moreover, by taking the array partition as the minimum reflection unit, the size of the array partition is greatly different from the transmission distance of the signal. Thus, the far field assumption is applicable to the single array partition.

In the precoding method according to the embodiment of the present disclosure, the first network device can determine the precoding matrix indication information based on the PMI information and the incidence angle information.

The PMI information is determined by the terminal and reported to the first network device. The incidence angle information is determined by the first network device.

In an implementation, the terminal performs the channel estimation according to the reference signal sent by the first network device, selects the most suitable precoding matrix from the codebook including the plurality of precoding matrices according to the channel estimation result, and feeds back the precoding matrix to the first network device via the PMI information.

In an implementation, the incidence angle information represents the incidence angle generated in a case where the first network device sends the signal to the massive antenna array. Typically, positions of the first network device and the massive antenna array are fixed. Thus, the incidence angle information is known for the first network device and the massive antenna array.

FIG. 15 is a flowchart showing that precoding matrix indication information is determined according to an example. As shown in FIG. 15, the method includes the following steps.

In S1201, receive the PMI information corresponding to the reference signal in the one or more array partitions reported by the terminal.

In an implementation, the terminal performs the channel estimation on the reference signal sent by each array partition to determine the PMI information corresponding to the reference signal in each array partition.

In some embodiments, the PMI information includes the horizontal PMI and the vertical PMI.

In S1202, determine the precoding matrix indication information based on the PMI information and the incidence angle information.

In some embodiments, the precoding matrix indication information includes: at least one of the PMI or the phase coefficient corresponding to the precoding matrix for the one or more array partitions. The first network device can determine the precoding matrix for each array partition according to at least one of the PMI or the phase coefficient corresponding to each array partition.

In an implementation, the phase needs to be adjusted for the PMI corresponding to array partition. Thus, the phase to be adjusted for the array partition is determined via the phase coefficient.

In some embodiments, precoding matrix indication information includes: the precoding matrix in the one or more array partitions. After the precoding matrix indication information is sent to the second network device, the second network device directly determines the precoding matrix for each array partition according to the precoding matrix indication information.

Determination of the precoding matrix for the array partition by the first network device will be described below with examples.

The array partition having the size of M*N is taken as an example. The horizontal PMI and the vertical PMI corresponding to the reference signal in the array partition reported by the terminal are received, and corresponding angle vectors are determined according to the horizontal PMI and the vertical PMI:

$$a ( {m}_{1} ) = [ 1 , {e}^{J \frac{2 π {m}_{1}}{{NO}_{1}}} , {e}^{j \frac{2 π 2 {m}_{1}}{{NO}_{1}}} , … , {e}^{j \frac{2 π ( N - 1 ) {m}_{1}}{{NO}_{1}}} ]$$

$$a ( {m}_{2} ) = [ 1 , {e}^{J \frac{2 π {m}_{2}}{{NO}_{2}}} , {e}^{j \frac{2 π 2 {m}_{2}}{{NO}_{2}}} , … , {e}^{j \frac{2 π ( N - 1 ) {m}_{2}}{{NO}_{2}}} ]$$

m₁ represents the horizontal PMI corresponding to the reference signal in the array partition, m₂ represents the vertical PMI corresponding to the reference signal in the array partition, α(m₁) represents the angle vector to be supplemented in the horizontal dimension determined based on the horizontal PMI, α(m₂) represents the angle vector to be supplemented in the vertical dimension determined based on the vertical PMI, O₁ and O₂ represent the oversampling factors, and j represents the imaginary part.

Corresponding angle vectors are determined according to the incidence angle in the horizontal dimension and the incidence angle in the vertical dimension:

$$a ( {α}_{h} ) = [ 1 , {e}^{j \frac{2 π}{λ} {d}_{1} cos {α}_{h}} , {e}^{j \frac{2 π}{λ} 2 {d}_{1} cos {α}_{h}} , … , {e}^{j \frac{2 π}{λ} {Nd}_{1} cos {α}_{h}} ]$$

$$a ( {α}_{v} ) = [ 1 , {e}^{j \frac{2 π}{λ} {d}_{2} cos {α}_{v}} , {e}^{j \frac{2 π}{λ} 2 {d}_{2} cos {α}_{v}} , … , {e}^{j \frac{2 π}{λ} {Md}_{2} cos {α}_{v}} ]$$

αₕ represents the incidence angle in the horizontal dimension, αᵥ represents the incidence angle in the vertical dimension, α(αₕ) represents the angle vector to be supplemented in the horizontal dimension determined according to the incidence angle in the horizontal dimension, α(αᵥ) represents the angle vector to be supplemented in the vertical dimension determined according to the incidence angle in the vertical dimension, d₁ represents the antenna spacing in the horizontal direction in the array partition, d₂ represents the antenna spacing in the vertical direction in the array partition, and j represents the imaginary part.

Thus, the angle vector of the array partition to be supplemented in the horizontal dimension is: α(γₕ)=α(m₁)⊙α(αₕ)·γₕ represents the angle of the array partition to be supplemented in the horizontal dimension, α(γₕ) represents the angle vector of the array partition to be supplemented in the horizontal dimension, α(m₁) represents the angle vector to be supplemented in the horizontal dimension determined based on the horizontal PMI, and α(αₕ) represents the angle vector to be supplemented in the horizontal dimension determined according to the incidence angle in the horizontal dimension.

The angle vector of the array partition to be supplemented in the vertical direction is: α(γᵥ)=α(m₂)⊙α(αᵥ)·γᵥ represents the angle of the array partition to be supplemented in the vertical dimension, α(γᵥ) represents the angle vector of the array partition to be supplemented in the vertical dimension, α(m₂) represents the angle vector to be supplemented in the vertical dimension determined based on the vertical PMI, and α(αᵥ) represents the angle vector to be supplemented in the vertical dimension determined according to the incidence angle in the vertical dimension.

Further, the precoding matrix for the array partition is α(γᵥ)^{T}α(γₕ).

In the embodiment of the present disclosure, the first network device can determine the precoding matrix indication information corresponding to the one or more array partitions by receiving the PMI information corresponding to the reference signal in the one or more array partitions reported by the terminal, and further determine the precoding matrix for the one or more array partitions based on the precoding matrix indication information. It can be seen that in the embodiment of the present disclosure, the precoding matrix for each array partition is determined separately by dividing the massive antenna array into the plurality of array partitions. Thus, complexity of precoding is reduced compared with the related art taking the massive antenna array as a whole for precoding.

In the precoding method according to the embodiment of the present disclosure, the first configuration information includes at least one of:
the array partition corresponding to the reference signal;
the time-frequency resource occupied by the reference signal; or
the sequence information of the reference signal.

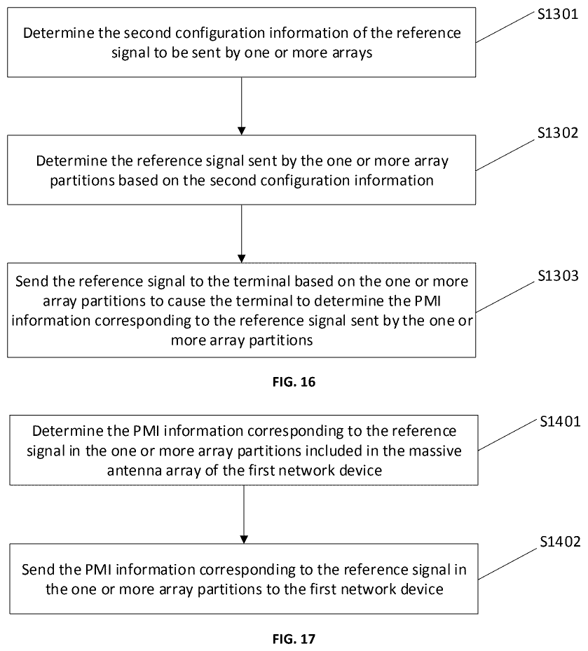

In the precoding method according to the embodiment of the present disclosure, when performing the channel estimation on the reference signal in each array partition, the terminal further needs to receive the reference signal sent by the first network device via the array partition. Thus, the first network device needs to determine the reference signal sent by each array partition. Thus, after configuring and activating the reference signal based on reference signal position information included in the massive antenna array information, the first network device determines the second configuration information of the reference signal, and determines the reference signal sent by each array partition based on the second configuration information. On this basis, a flowchart showing that the reference signal sent by the array partition is determined is further provided in an embodiment of the present disclosure. As shown in FIG. 16, the method includes the following steps.

In S1301, determine the second configuration information of the reference signal to be sent by the one or more arrays.

In S1302, determine the reference signal sent by the one or more array partitions based on the second configuration information.

In S1303, send the reference signal to the terminal based on the one or more array partitions to cause the terminal to determine the PMI information corresponding to the reference signal sent by the one or more array partitions.

In the embodiment of the present disclosure, the first network device sends the reference signal to the terminal based on the one or more array partitions such that the terminal can perform the channel estimation on the reference signal, and determine the PMI information corresponding to each array partition. Complexity of precoding is reduced compared with the related art taking the massive antenna array as a whole for precoding. Moreover, by taking the array partition as the minimum reflection unit, the size of the array partition is greatly different from the transmission distance of the signal. Thus, the far field assumption is applicable to the single array partition.

In the precoding method according to the embodiment of the present disclosure, two manners of reporting the PMI information by the terminal are provided in a case where the terminal reports the PMI information to the first network device.

In some embodiments, the PMI information corresponding to the reference signal in the one or more array partitions reported by the terminal at one time is received.

In some other embodiments, the PMI information corresponding to the reference signal in the one or more array partitions reported by the terminal at one time is received.

In the precoding method according to the embodiment of the present disclosure, the massive antenna array is the RIS array.

FIG. 17 is a flowchart of a precoding method according to an example. As shown in FIG. 17, the precoding method is applied to the terminal, and includes the following steps.

In S1401, determine the PMI information corresponding to the reference signal in the one or more array partitions included in the massive antenna array of the first network device.

In an implementation, the terminal performs the channel estimation according to the reference signal sent by the first network device, selects the most suitable precoding matrix from the codebook including the plurality of precoding matrices according to the channel estimation result, and determines the PMI information via the precoding matrix.

In S1402, send the PMI information corresponding to the reference signal in the one or more array partitions to the first network device.

The PMI information is configured to determine precoding matrix indication information by the first network device, and the precoding matrix indication information is configured to determine, by the first network device, the precoding matrix for the one or more array partitions included in the massive antenna array.

In some embodiments, the precoding matrix indication information is determined by the first network device based on the PMI information and the incidence angle information.

The PMI information is determined by the terminal and reported to the first network device. The incidence angle information is determined by the first network device.

In an implementation, the terminal performs the channel estimation according to the reference signal sent by the first network device, selects the most suitable precoding matrix from the codebook including the plurality of precoding matrices according to the channel estimation result, and feeds back the precoding matrix to the first network device via the PMI information. Incidence angle information represents the incidence angle generated in a case where the first network device sends the signal to the massive antenna array. Typically, positions of the first network device and the massive antenna array are fixed. Thus, the incidence angle information is known for the first network device and the massive antenna array.

In some embodiments, the precoding matrix indication information may include: at least one of the PMI or the phase coefficient corresponding to the precoding matrix for the one or more array partitions; or the precoding matrix for the one or more array partitions.

In an implementation, the precoding matrix indication information includes: at least one of the PMI or the phase coefficient corresponding to the precoding matrix for one or more array partitions. The phase needs to be adjusted for the PMI corresponding to the array partition. Thus, the phase to be adjusted for the array partition is determined via the phase coefficient.

In the embodiment of the present disclosure, the terminal can determine the PMI information corresponding to the reference signal in the one or more array partitions included in the massive antenna array of the first network device. After sending the PMI information corresponding to the reference signal in the one or more array partitions to the first network device, the first network device can determine the precoding matrix indication information of the one or more array partitions based on the PMI information. It can be seen that in the embodiment of the present disclosure, the precoding matrix indication information of each array partition is determined separately by dividing the massive antenna array into the plurality of array partitions. Thus, complexity of precoding is reduced compared with the related art taking the massive antenna array as a whole for precoding. Moreover, by taking the array partition as the minimum reflection unit, the size of the array partition is greatly different from the transmission distance of the signal. Thus, the far field assumption is applicable to the single array partition.

In the precoding method according to the embodiment of the present disclosure, when determining the PMI information corresponding to the reference signal in the one or more array partitions, the terminal needs to obtain configuration information of the reference signal to determine a corresponding relation between the reference signal and the array partition, so as to perform the channel estimation on the reference signal in each array partition and determine the PMI information corresponding to each array partition.

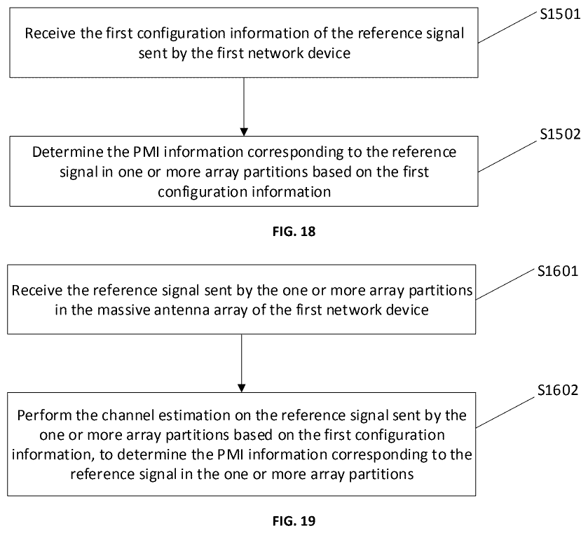

On this basis, a method for determining PMI information is further provided in an embodiment of the present disclosure. As shown in FIG. 18, the method includes the following steps.

In S1501, receive the first configuration information of the reference signal sent by the first network device.

The first configuration information is determined by the first network device by configuring and activating the reference signal based on the reference signal position information included in the massive antenna array information.

In S1502, determine the PMI information corresponding to the reference signal in the one or more array partitions based on the first configuration information.

In some embodiments, the first configuration information includes at least one of:
the array partition corresponding to the reference signal;
the time-frequency resource occupied by the reference signal; or
the sequence information of the reference signal.

In the embodiment of the present disclosure, the terminal determines the PMI information corresponding to the reference signal in the one or more array partitions based on the first configuration information of the reference signal by sending the first configuration information of the reference signal to the terminal. Thus, after the terminal reports the PMI information to the first network device, the first network device can determine the precoding matrix indication information of the one or more partitions based on the PMI information, and further determine the precoding matrix for the one or more array partitions based on the precoding matrix indication information. It can be seen that in the embodiment of the present disclosure, the precoding matrix for each array partition is determined separately by dividing the massive antenna array into the plurality of array partitions. Thus, complexity of precoding is reduced compared with the related art taking the massive antenna array as a whole for precoding.

In the precoding method according to the embodiment of the present disclosure, when performing the channel estimation on the reference signal in each array partition, the terminal further needs to receive the reference signal sent by the first network device via the array partition, and further performs the channel estimation on the received reference signal to determine the corresponding PMI information. On this basis, a method for determining the reference signal sent by the array partition is further provided in an embodiment of the present disclosure. As shown in FIG. 19, the method includes the following steps.

In S1601, receive the reference signal sent by the one or more array partitions in the massive antenna array of the first network device.

The first network device determines the reference signal sent by the one or more array partitions based on the second configuration information of the reference signal, and sends the corresponding reference signal to the terminal based on the one or more array partitions.

In S1602, perform the channel estimation on the reference signal sent by the one or more array partitions based on the first configuration information, to determine the PMI information corresponding to the reference signal in the one or more array partitions.

In the embodiment of the present disclosure, the first network device sends the reference signal to the terminal based on the one or more array partitions such that the terminal can perform the channel estimation on the reference signal, and determine the PMI information corresponding to each array partition. Complexity of precoding is reduced compared with the related art taking the massive antenna array as a whole for precoding. Moreover, by taking the array partition as the minimum reflection unit, the size of the array partition is greatly different from the transmission distance of the signal. Thus, the far field assumption is applicable to the single array partition.

In the precoding method according to the embodiment of the present disclosure, two manners of reporting the PMI information by the terminal are provided in a case where the terminal reports the PMI information to the first network device.

In some embodiments, the PMI information corresponding to the reference signal in the one or more array partitions is reported to the first network device at one time.

In some other embodiments, the PMI information corresponding to the reference signal in the one or more array partitions is reported to the first network device a plurality of times.

The PMI information reported each time of the plurality of times includes the PMI information corresponding to the reference signal in the one or more array partitions.

In the precoding method according to the embodiment of the present disclosure, the massive antenna array is the RIS array.

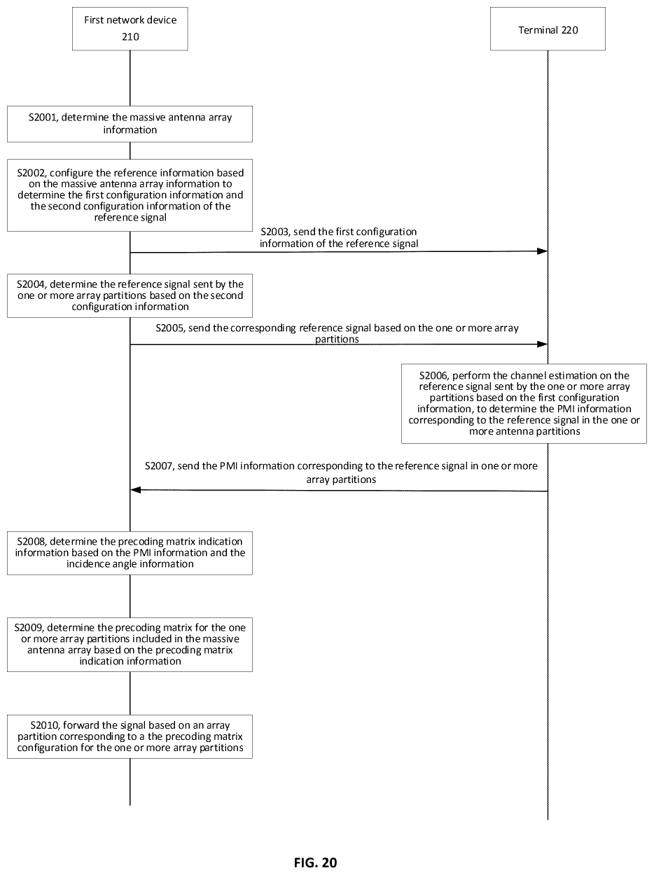

In order to more clearly explain the precoding method according to the embodiment of the present disclosure, the precoding method according to the embodiment of the present disclosure will be described below in an interactive form. As shown in FIG. 20, the precoding method includes the following steps.

S2001, the first network device 210 determines the massive antenna array information. That is, the first network device 210 obtains the massive antenna array information.

S2002, the first network device 210 configures the reference signal based on the massive antenna array information to determine the first configuration information and the second configuration information of the reference signal. The massive antenna array information at least includes partition information of the array partition.

S2003, the first network device 210 sends the first configuration information of the reference signal to the terminal 220.

S2004, the first network device 210 determines the reference signal sent by the one or more array partitions based on the second configuration information.

S2005, the first network device 210 sends the reference signal to the terminal 220 based on the one or more array partitions.

S2006, after receiving the first configuration information and the reference signal sent by the one or more array partitions, the terminal 220 performs the channel estimation on the reference signal in the one or more array partitions to determine the PMI information corresponding to the reference signal in the one or more array partitions via measurement.

S2007, the terminal 220 sends the PMI information corresponding to the reference signal in the one or more array partitions to the first network device 210.

S2008, the first network device 210 determines the precoding matrix indication information of the one or more partitions according to the received PMI information and the incidence angle information.

S2009, the first network device 210 determines the precoding matrix corresponding to the one or more array partitions based on the precoding matrix indication information.

S2010, the first network device 210 forwards the signal based on an array partition corresponding to a precoding matrix configuration for the one or more array partitions. That is, the first network device 210 configures the antenna port corresponding to the precoding matrix based on the precoding matrix for the one or more array partitions, so as to forward the signal.

In some embodiments, in a case where the massive antenna array is the RIS array, the signal may be at least one of reflected or transmitted.

In the embodiment of the present disclosure, the precoding matrix for each array partition is determined separately by dividing the massive antenna array into the plurality of array partitions. Thus, complexity of precoding is reduced compared with the related art taking the massive antenna array as a whole for precoding. Moreover, by taking the array partition as the minimum reflection unit, the size of the array partition is greatly different from the transmission distance of the signal. Thus, the far field assumption is applicable to the single array partition.

It should be noted that those skilled in the art can understand that various implementations or embodiments involved above in the embodiments of the present disclosure can be used in cooperation with the embodiments above, or can be used separately. Whether various implementations or embodiments are used separately or in cooperation with the embodiments above, the implementation principles of the implementations or embodiments are similar. In the implementation of the present disclosure, some of the embodiments are described along with the implementations used together. Those skilled in the art can understand that such illustrations are not intended to limit the embodiments of the present disclosure.

Based on the same concept, a precoding device is further provided in an embodiment of the present disclosure.

It can be understood that the precoding device according to the embodiment of the present disclosure includes at least one of hardware structures or software modules corresponding to execution of each function in order to achieve the above functions. In combination with the units and algorithm steps of various examples disclosed in the embodiments of the present disclosure, the embodiments of the present disclosure can be implemented in hardware or a combination of hardware and computer software. Whether a function is executed by hardware or computer software driven hardware depends on the specific application and design constraints of the technical solution. Those skilled in the art can implement the described functions for each specific application by using different methods, but such implementation should not be considered beyond the scope of the technical solution of the embodiment of the present disclosure.

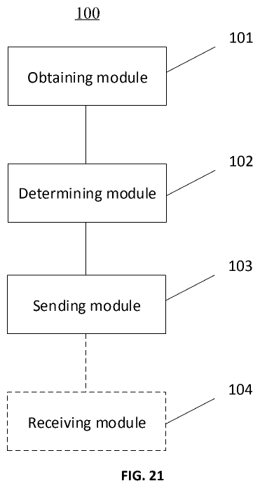

FIG. 21 is a block diagram of a precoding device according to an example. With reference to FIG. 21, the device 100 includes an obtaining module 101, a determining module 102 and a sending module 103.

The obtaining module 101 is configured to obtain massive antenna array information of a second network device, where the massive antenna array information at least includes array partition information;

the determining module 102 is configured to determine precoding matrix indication information based on the array partition information included in the massive antenna array information, where the precoding matrix indication information is configured to determine, by the second network device, a precoding matrix for one or more array partitions included in a massive antenna array; and

the sending module 103 is configured to send the precoding matrix indication information to the second network device.

In an implementation, the device 100 further includes a receiving module 104. The receiving module 104 is configured to receive PMI information corresponding to a reference signal in the one or more array partitions reported by a terminal; and the determining module 102 is configured to determine the precoding matrix indication information based on the PMI information and incidence angle information.

In an implementation, the sending module 103 is configured to send first configuration information of the reference signal to the terminal, where the first configuration information is configured to determine, by the terminal, the PMI information corresponding to the reference signal in the one or more array partitions.

In an implementation, the first configuration information includes at least one of:
an array partition corresponding to the reference signal;
a time-frequency resource occupied by the reference signal; or
sequence information of the reference signal.

In an implementation, the receiving module 104 is configured to receive the PMI information corresponding to the reference signal in the one or more array partitions reported by the terminal at one time; or receive the PMI information corresponding to the reference signal in the one or more array partitions reported by the terminal a plurality of times, where the PMI information reported each time of the plurality of times includes the PMI information corresponding to the reference signal in the one or more array partitions.

In an implementation, the sending module 103 is configured to send second configuration information of the reference signal to the second network device, where the second configuration information is configured to determine, by the second network device, the reference signal sent by the one or more array partitions in the massive antenna array.

In an implementation, the precoding matrix indication information includes: at least one of a PMI or a phase coefficient corresponding to the precoding matrix for the one or more array partitions; or the precoding matrix for the one or more array partitions.

In an implementation, the obtaining module 101 is configured to obtain the massive antenna array information reported by the second network device; or obtain the massive antenna array information stored offline by a core network device from the core network device.

In an implementation, the massive antenna array includes a reconfigurable intelligent surface (RIS) array of an RIS.

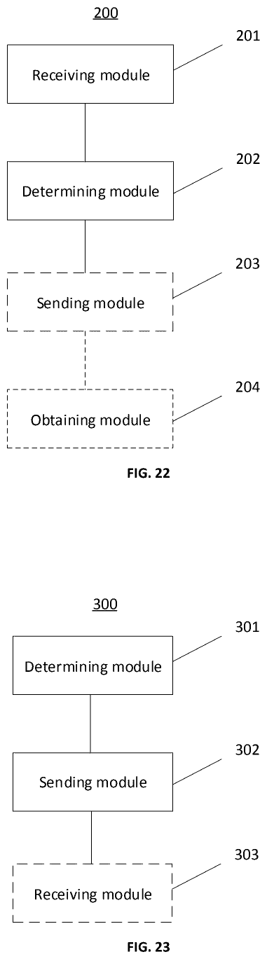

FIG. 22 is a block diagram of a precoding device according to an example. With reference to FIG. 22, the device 200 includes a receiving module 201 and a determining module 202.

The receiving module 201 is configured to receive precoding matrix indication information sent by a first network device; and

the determining module 202 is configured to determine a precoding matrix for one or more array partitions included in a massive antenna array of the second network device, based on the precoding matrix indication information.

In an implementation, the device 200 further includes a sending module 203. The sending module 203 is configured to send massive antenna array information to the first network device, where the massive antenna array information at least includes array partition information, and the array partition information is configured to determine the precoding matrix indication information by the first network device.

In an implementation, the device 200 further includes an obtaining module 204. The obtaining module 204 is configured to obtain second configuration information of a reference signal to be sent by the one or more array partitions; the determining module 202 is configured to determine the reference signal sent by the one or more array partitions based on the second configuration information; and the sending module 203 is configured to send the reference signal to a terminal based on the one or more array partitions to cause the terminal to determine PMI information corresponding to the reference signal sent by the one or more array partitions.

In an implementation, the obtaining module 204 is configured to receive the second configuration information of the reference signal sent by the first network device; or obtain the second configuration information of the reference signal stored offline by a core network device from the core network device.

In an implementation, the precoding matrix indication information includes: at least one of a PMI or a phase coefficient corresponding to the precoding matrix for the one or more array partitions; or the precoding matrix for the one or more array partitions.

In an implementation, the massive antenna array includes a reconfigurable intelligent surface (RIS) array of an RIS.

FIG. 23 is a block diagram of a precoding device according to an example. With reference to FIG. 23, the device 300 includes a determining module 301 and a sending module 302.

The determining module 301 is configured to determine PMI information corresponding to a reference signal in one or more array partitions included in a massive antenna array of a second network device; and

the sending module 302 is configured to send the PMI information corresponding to the reference signal in the one or more array partitions to a first network device, where the PMI information is configured to determine precoding matrix indication information by the first network device, and the precoding matrix indication information is configured to determine, by the second network device, a precoding matrix for the one or more array partitions included in the massive antenna array.

In an implementation, the device 300 further includes a receiving module 303. The receiving module 303 is configured to receive first configuration information of the reference signal sent by the first network device; and determine the PMI information corresponding to the reference signal in the one or more array partitions based on the first configuration information.

In an implementation, the first configuration information includes at least one of:
an array partition corresponding to the reference signal;
a time-frequency resource occupied by the reference signal; or
sequence information of the reference signal.

In an implementation, the receiving module 303 is configured to receive the reference signal sent by the one or more array partitions in the massive antenna array of the second network device; and

the determining module 301 is configured to perform channel estimation on the reference signal sent by the one or more array partitions based on the first configuration information, to determine the PMI information corresponding to the reference signal in the one or more array partitions.

In an implementation, the sending module 302 is configured to report the PMI information corresponding to the reference signal in the one or more array partitions to the first network device at one time; or
report the PMI information corresponding to the reference signal in the one or more array partitions to the first network device a plurality of times, where the PMI information reported each time of the plurality of times includes the PMI information corresponding to the reference signal in the one or more array partitions.

In an implementation, the massive antenna array includes a reconfigurable intelligent surface (RIS) array of an RIS.

For the device in the above embodiment, a specific mode for each module to perform an operation has been described in detail in the embodiment relating to the method, which will not be described in detail here.

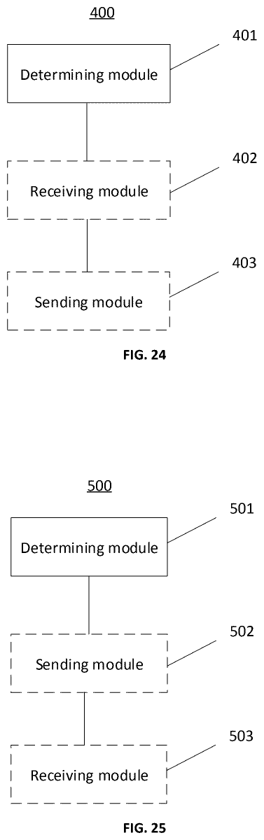

FIG. 24 is a block diagram of a precoding device according to an example. With reference to FIG. 24, the device 400 includes a determining module 401.

The determining module 401 is configured to determine massive antenna array information, where the massive antenna array information at least includes array partition information; determine precoding matrix indication information based on the array partition information included in the massive antenna array information; and determine a precoding matrix for one or more array partitions included in a massive antenna array based on the precoding matrix indication information.

In an implementation, the device 400 further includes a receiving module 402. The receiving module 402 is configured to receive PMI information corresponding to a reference signal in the one or more array partitions reported by a terminal; and
the determining module 401 is configured to determine the precoding matrix indication information based on the PMI information and incidence angle information.

In an implementation, the device 400 further includes a sending module 403. The sending module 403 is configured to send first configuration information of the reference signal to the terminal, where the first configuration information is configured to determine, by the terminal, the PMI information corresponding to the reference signal in the one or more array partitions.

In an implementation, the first configuration information includes at least one of:
an array partition corresponding to the reference signal;
a time-frequency resource occupied by the reference signal; or
sequence information of the reference signal.

In an implementation, the receiving module 402 is configured to receive the PMI information corresponding to the reference signal in the one or more array partitions reported by the terminal at one time; or receive the PMI information corresponding to the reference signal in the one or more array partitions reported by the terminal a plurality of times, where the PMI information reported each time of the plurality of times includes the PMI information corresponding to the reference signal in the one or more array partitions.

In an implementation, the determining module 401 is configured to determine second configuration information of a reference signal to be sent by the one or more arrays; determine the reference signal sent by the one or more array partitions based on the second configuration information; and send the reference signal to the terminal based on the one or more array partitions to cause the terminal to determine the PMI information corresponding to the reference signal sent by the one or more array partitions.

In an implementation, the precoding matrix indication information includes: at least one of a PMI or a phase coefficient corresponding to the precoding matrix for the one or more array partitions; or the precoding matrix for the one or more array partitions.

In an implementation, the massive antenna array includes a reconfigurable intelligent surface (RIS) array of an RIS.

FIG. 25 is a block diagram of a precoding device according to an example. With reference to FIG. 25, the device 500 includes a determining module 501 and a sending module 502.

The determining module 501 is configured to determine PMI information corresponding to a reference signal in one or more array partitions included in a massive antenna array of a first network device; and
the sending module 502 is configured to send the PMI information corresponding to the reference signal in the one or more array partitions to the first network device, where the PMI information is configured to determine precoding matrix indication information by the first network device, and the precoding matrix indication information is configured to determine, by the first network device, a precoding matrix for the one or more array partitions included in the massive antenna array.

In an implementation, the device 500 further includes a receiving module 503. The receiving module 503 is configured to receive first configuration information of the reference signal sent by the first network device; and
the determining module 501 is configured to determine the PMI information corresponding to the reference signal in the one or more array partitions based on the first configuration information.

In an implementation, the first configuration information includes at least one of:
an array partition corresponding to the reference signal;
a time-frequency resource occupied by the reference signal; or
sequence information of the reference signal.

In an implementation, the receiving module 503 is configured to receive the reference signal sent by the one or more array partitions in the massive antenna array of the first network device; and

the determining module 501 is configured to perform channel estimation on the reference signal sent by the one or more array partitions based on the first configuration information, to determine the PMI information corresponding to the reference signal in the one or more array partitions.

In an implementation, the sending module is configured to report the PMI information corresponding to the reference signal in the one or more array partitions to the first network device at one time; or report the PMI information corresponding to the reference signal in the one or more array partitions to the first network device a plurality of times, where the PMI information reported each time of the plurality of times includes the PMI information corresponding to the reference signal in the one or more array partitions.

In an implementation, the massive antenna array includes a reconfigurable intelligent surface (RIS) array of an RIS.

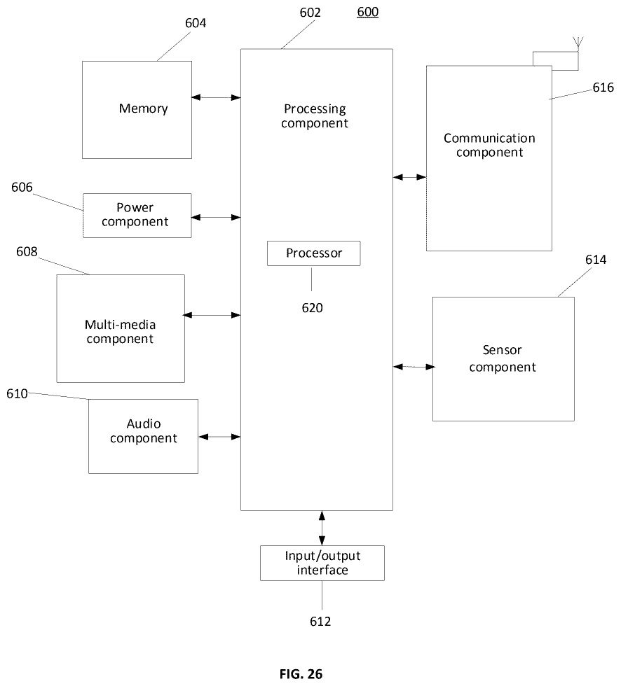

FIG. 26 is a block diagram of a device 600 for precoding according to an example. For example, the device 600 may be a mobile phone, a computer, a digital broadcast terminal, a message transmitting and receiving device, a game console, a tablet device, a medical device, a fitness device, a personal digital assistant, etc.

With reference to FIG. 26, the device 600 may include one or more of the following components: a processing component 602, a memory 604, a power component 606, a multi-media component 608, an audio component 610, an input/output (I/O) interface 612, a sensor component 614 and a communication component 616.

Overall operations of the device 600, such as operations associated with display, phone calls, data communications, camera operations and recording operations, are generally controlled by the processing component 602. The processing component 602 may include one or more processors 620 to execute instructions to complete all or some of steps of the method described above. Further, the processing component 602 may include one or more modules that facilitate interaction between the processing component 602 and other components. For example, the processing component 602 may include a multi-media module, so as to facilitate interaction between the multi-media component 608 and the processing component 602.

As used herein, the term processor may refer to one processor that performs the defined functions or a plurality of processors that collectively perform defined functions, such that the execution of the individual defined functions may be divided amongst such processors.

The memory 604 is configured to store any type of data to support operations at the device 600. Examples of such data include instructions, contact data, phone book data, messages, pictures, videos, etc., for any application or method operated on the device 600. The memory 604 may be implemented by any type of volatile or non-volatile storage device, or a combination of any type of volatile or non-volatile storage device, such as a static random access memory (SRAM), an electrically erasable programmable read-merely memory (EEPROM), an erasable programmable read-merely memory (EPROM), a programmable read-merely memory (PROM), a read-merely memory (ROM), a magnetic memory, a flash memory, a magnetic disk, or an optical disk.

Power is provided by the power component 606 for various components of the device 600. The power component 606 may include a power management system, one or more power supplies, and other components associated with generation, management and distribution of power for the device 600.

The multi-media component 608 includes a screen that provides an output interface between the device 600 and a user. In some embodiments, a screen may include a liquid crystal display (LCD) and a touch panel (TP). If the screen includes the TP, the screen may be implemented as a touch screen to receive an input signal from a user. The TP includes one or more touch sensors to sense touch, swipe, and gestures on the TP. A boundary of a touch or swipe action may be sensed by the touch sensor, and duration and pressure associated with a touch or swipe operation may be further detected by the touch sensor. In some embodiments, a multi-media component 608 includes a front-facing camera and/or a rear-facing camera. When the device 600 is in an operation mode, such as a photographing mode or a video mode, external multi-media data may be received by the front-facing camera and/or the rear-facing camera. Each front-facing camera and each rear-facing camera may be a fixed optical lens system or have a focal length and an optical zoom capability.

The audio component 610 is configured to at least one of output or input an audio signal. For example, the audio component 610 includes a microphone (MIC). The MIC is configured to receive an external audio signal when the device 600 is in an operating mode, such as a call mode, a recording mode, and a voice recognition mode. The received audio signal may be further stored in the memory 604 or sent via the communication component 616. In some embodiments, an audio component 610 further includes a loudspeaker for outputting an audio signal.

An interface is provided by the I/O interface 612 between the processing component 602 and a peripheral interface module. The peripheral interface module described above may be a keyboard, a click wheel, a button, etc. The button may include, but not limited to, a home button, a volume button, a start button, and a lock button.

The sensor component 614 includes one or more sensors configured to providing state assessments of various aspects for the device 600. For example, an on or off state of the device 600, and a relative positioning effect of components may be detected by the sensor component 614. For example, the component is a display and a keypad of the device 600. A change in position of the device 600 or a component of the device 600, presence or absence of the user making contact with the device 600, orientation or acceleration/deceleration of the device 600, and a change in temperature of the device 600 may be further detected by the sensor component 614. The sensor component 614 may include a proximity sensor configured to detect presence of nearby objects in the absence of any physical contact. The sensor component 614 may further include a light sensor, such as a complementary metal-oxide-semiconductor (CMOS) image sensor or a charge coupled device (CCD) image sensor, used in imaging applications. In some embodiments, a sensor component 614 may further include an acceleration sensor, a gyro sensor, a magnetic sensor, a pressure sensor, or a temperature sensor.

The communication component 616 is configured to facilitate communication between the device 600 and other devices in a wired or wireless manner. A wireless network based on a communication standard, such as wireless fidelity (WiFi), 2G, 3G or a combination of the WiFi, the 2G and the 3G, may be accessed by the device 600. In an example, a broadcast signal or broadcast related information from an external broadcast management system is received by a communication component 616 via a broadcast channel. In an example, a communication component 616 further includes a near field communication (NFC) module to facilitate short range communication. For example, the NFC module may be implemented based on a radio frequency identification (RFID) technology, an infrared data association (IrDA) technology, an ultra wide band (UWB) technology, a Bluetooth (BT) technology, and other technologies.

In an example, a device 600 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, micro-processors, or other electronic elements, and is configured to perform the method described above.

In an example, a non-transitory computer-readable storage medium including instructions is further provided, such as a memory 604 including instructions. The instructions are executable by a processor 620 of a device 600, so as to complete the method described above. For example, the non-transitory computer-readable storage medium may be a ROM, a random access memory (RAM), a compact disc read-merely memory (CD-ROM), a magnetic tape, a floppy disk, an optical data storage device, etc.

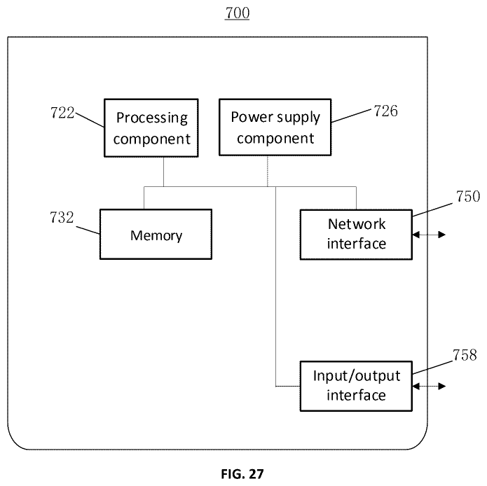

FIG. 27 is a block diagram of a device 700 for precoding according to an example. For example, the device 700 may be provided as a server. With reference to FIG. 27, the device 700 includes a processing component 722. The processing component further includes one or more processors, and memory resources represented by a memory 732, which are configured to store instructions, e.g., an application, executable by the processing component 722. The application stored in the memory 732 may include one or more modules, each corresponding to a set of instructions. Further, the processing component 722 is configured to execute the instructions, so as to perform the precoding method described above.

The device 700 may further include a power supply component 726 configured to perform power management of the device 700, a wired or wireless network interface 750 configured to connect the device 700 to a network, and an I/O interface 758. The device 700 may operate on an operating system stored in the memory 732, such as Windows Server™, Mac OS X™, Unix™, Linux™, FreeBSD™, or the like.

Further, it can be understood that “plurality” in the present disclosure refers to two or more, and other quantifiers are similar to the term. “And/or” describes an associated relation of an associated object, and indicates that three relations may exist. For example, A and/or B may indicate that A exists separately, A and B exist simultaneously, and B exists separately. The character “/” generally indicates that front and rear associated objects are in an “or” relation. The singular forms such as “a,” “an,” “the” and “this” are also intended to include the plural forms, unless otherwise clearly stated in the context.

Further, it can be understood that the meanings of the words such as “in response to” and “if” mentioned in the present disclosure depend on the context and the actual usage scenario. For example, the word “in response to” used here can be interpreted as “at the time of,” “when” or “if”.

Further, it can be understood that the terms “first,” “second,” etc. are used to describe various information, but this information is not limited by these terms. These terms are merely used to distinguish the same type of information from each other, and do not indicate a particular order or importance. In fact, the expressions “first,” “second,” etc. can be used interchangeably. For example, without departing from the scope of the present disclosure, the first information may also be referred to as second information, and similarly, the second information may also be referred to as first information.

Further, it can be understood that although operations are depicted in a particular order in the accompanying drawings in the embodiments of the present disclosure, the operations should not be construed as requiring that such operations are performed in the particular order shown or in a serial order, or that all illustrated operations are performed to achieve desired results. In a particular environment, multitasking and parallel processing may be advantageous.

Those skilled in the art easily conceive of other implementation solutions of the present disclosure upon consideration of the description and practice of the invention disclosed here. The present application is intended to cover any variations, uses or adaptive changes of the present disclosure. The variations, uses or adaptive changes follow the general principles of the present disclosure and include common general knowledge or customary technical means, which is not disclosed in the present disclosure, in the technical field.

It should be understood that the present disclosure is not limited to a precise structure which has been described above and illustrated in the accompanying drawings, and various modifications and changes can be made to the present disclosure without departing from the scope of the present disclosure. The scope of the present disclosure is limited by the appended claims merely.

1. A precoding method, performed by a first network device, the precoding method comprising:
obtaining massive antenna array information of a second network device, wherein the massive antenna array information at least comprises array partition information;
determining precoding matrix indication information based on the array partition information comprised in the massive antenna array information, wherein the precoding matrix indication information is configured to determine, by the second network device, a precoding matrix for one or more array partitions comprised in a massive antenna array; and
sending the precoding matrix indication information to the second network device.

2. The precoding method according to claim 1, wherein determining the precoding matrix indication information based on the array partition information comprised in the massive antenna array information comprises:
receiving precoding matrix indicator (PMI) information corresponding to a reference signal in the one or more array partitions reported by a terminal; and
determining the precoding matrix indication information based on the PMI information and incidence angle information.

3. The precoding method according to claim 2, further comprising:
sending first configuration information of the reference signal to the terminal, wherein the first configuration information is configured to determine, by the terminal, the PMI information corresponding to the reference signal in the one or more array partitions; or
sending second configuration information of the reference signal to the second network device, wherein the second configuration information is configured to determine, by the second network device, a reference signal sent by the one or more array partitions in the massive antenna array.

4. The precoding method according to claim 3, wherein the first configuration information comprises at least one of the following:
an array partition corresponding to the reference signal;
a time-frequency resource occupied by the reference signal; or
sequence information of the reference signal.

5. The precoding method according to claim 2, wherein receiving the PMI information corresponding to the reference signal in the one or more array partitions reported by the terminal comprises:
receiving the PMI information corresponding to the reference signal in the one or more array partitions reported by the terminal at one time; or
receiving the PMI information corresponding to the reference signal in the one or more array partitions reported by the terminal a plurality of times, wherein PMI information reported each time of the plurality of times comprises the PMI information corresponding to the reference signal in the one or more array partitions.

6. (canceled)

7. The precoding method according to claim 1, wherein the precoding matrix indication information comprises:
at least one of a precoding matrix indicator (PMI) or a phase coefficient corresponding to the precoding matrix for the one or more array partitions; or
the precoding matrix for the one or more array partitions; or
wherein the massive antenna array comprises a reconfigurable intelligent surface (RIS) array of an RIS.

8. The precoding method according to claim 1, wherein obtaining the massive antenna array information comprises:
obtaining the massive antenna array information reported by the second network device; or
obtaining the massive antenna array information stored offline by a core network device from the core network device.

9. (canceled)

10. A precoding method, performed by a second network device, the precoding method comprising:
receiving precoding matrix indication information sent by a first network device; and
determining a precoding matrix for one or more array partitions comprised in a massive antenna array of the second network device, based on the precoding matrix indication information.

11. The precoding method according to claim 10, further comprising:
sending massive antenna array information to the first network device, wherein the massive antenna array information at least comprises array partition information, and the array partition information is configured to determine the precoding matrix indication information by the first network device.

12. The precoding method according to claim 11, further comprising:
obtaining second configuration information of a reference signal to be sent by the one or more array partitions;
determining the reference signal sent by the one or more array partitions based on the second configuration information; and
sending the reference signal to a terminal based on the one or more array partitions to cause the terminal to determine precoding matrix indicator (PMI) information corresponding to the reference signal sent by the one or more array partitions.

13. The precoding method according to claim 12, wherein obtaining the second configuration information of the reference signal to be sent by the one or more array partitions comprises:
receiving the second configuration information of the reference signal sent by the first network device; or
obtaining the second configuration information of the reference signal stored offline by a core network device from the core network device.

14. The precoding method according to claim 10, wherein the precoding matrix indication information comprises:
at least one of a precoding matrix indicator (PMI) or a phase coefficient corresponding to the precoding matrix for the one or more array partitions; or
the precoding matrix for the one or more array partitions; or
wherein the massive antenna array comprises a reconfigurable intelligent surface (RIS) array of an RIS.

15. (canceled)

16. A precoding method, performed by a terminal, the precoding method comprising:
determining precoding matrix indicator (PMI) information corresponding to a reference signal in one or more array partitions comprised in a massive antenna array of a second network device; and
sending the PMI information corresponding to the reference signal in the one or more array partitions to a first network device, wherein the PMI information is configured to determine precoding matrix indication information by the first network device, and the precoding matrix indication information is configured to determine, by the second network device, a precoding matrix for the one or more array partitions comprised in the massive antenna array.

17. The precoding method according to claim 16, further comprising:
receiving first configuration information of a reference signal sent by the first network device; and
determining the PMI information corresponding to the reference signal in the one or more array partitions based on the first configuration information.

18. The precoding method according to claim 17, wherein the first configuration information comprises at least one of the following:
an array partition corresponding to the reference signal;
a time-frequency resource occupied by the reference signal; or
sequence information of the reference signal.

19. The precoding method according to claim 17, wherein determining the PMI information corresponding to the reference signal in the one or more array partitions based on the first configuration information comprises:
receiving the reference signal sent by the one or more array partitions in the massive antenna array of the second network device; and
performing channel estimation on the reference signal sent by the one or more array partitions based on the first configuration information, to determine the PMI information corresponding to the reference signal in the one or more array partitions.

20. The precoding method according to claim 16, wherein sending the PMI information corresponding to the reference signal in the one or more array partitions to the first network device comprises:
reporting the PMI information corresponding to the reference signal in the one or more array partitions to the first network device at one time; or
reporting the PMI information corresponding to the reference signal in the one or more array partitions to the first network device a plurality of times, wherein PMI information reported each time of the plurality of times comprises the PMI information corresponding to the reference signal in the one or more array partitions.

21. The precoding method according to claim 16, wherein the massive antenna array comprises a reconfigurable intelligent surface (RIS) array of an RIS.

22-40. (canceled)

41. A communication device, comprising:
one or more processors; and
a memory configured to store processor-executable instructions, wherein
the processor-executable instructions, when collectively executed by the one or more processors, cause the communication device to is configured to perform the precoding method according to claim 16.

42. A non-transitory computer storage medium storing instructions, wherein
the instructions, when executed by a processor of the terminal, cause the terminal to perform the precoding method according to claim 16.
